(19) United States
(12) Patent Application Publication
(10) Pub. No.: US 2014/0225783 A1
(43) Pub. Date: Aug. 14, 2014

(54) Apparatus and Methods of forming Molded Parts

(71) Applicant: Nokia Corporation, Espoo (FI)

(72) Inventors: Christian Saxe, Copenhagen East (DK); Dennis Sejersgaard-Jacobsen, Bronshoj (DK)

(73) Assignee: Nokia Corporation, Espoo (FI)

(21) Appl. No.: 14/342,812

(22) PCT Filed: Sep. 9, 2011
(86) PCT No.: PCT/IB2011/053958

§ 371 Date: Mar. 5, 2014

(51) Int. Cl. H01Q 1/36; B29C 70/68

(52) U.S. Cl. CPC H01Q 1/36; B29C 70/68
USPC 343/700 MS; 264/446; 264/255

(57) ABSTRACT

An apparatus including a first molded part including a plurality of protrusions; and a second molded part, molded at least to the plurality of protrusions of the first molded part, the second molded part including an antenna configured to resonate at radio frequencies.

### TECHNOLOGICAL FIELD

Embodiments of the present invention relate to apparatus and methods of forming molded parts. In particular, they relate to apparatus in hand portable electronic devices.

### BACKGROUND

Apparatus, such as portable electronic communication devices, usually comprise one or more antennas for wireless communication. The antennas are usually manufactured separate to the apparatus and are subsequently mounted and connected within the apparatus. However, such antennas may not be placed accurately within the apparatus and the positioning of the antennas may have relatively high mechanical tolerances.

It would therefore be desirable to provide an alternative apparatus.

### BRIEF SUMMARY

According to various, but not necessarily all, embodiments of the invention there is provided an apparatus comprising: a first molded part including a plurality of protrusions; a second molded part, molded at least to the plurality of protrusions of the first molded part, the second molded part including an antenna configured to resonate at radio frequencies.

The apparatus may be for wireless communication.

The first molded part may define a cavity and the plurality of protrusions may be positioned within the cavity, the second molded part may at least partially occupy the cavity.

The plurality of protrusions may comprise ribs extending along a longitudinal axis of the first molded part.

The cavity may define an upper surface and a lower surface, and a first subset of the plurality of protrusions may extend perpendicularly from the upper surface and a second subset of the plurality of protrusions may extend from the lower surface.

The antenna may include a feed point configured to couple to radio frequency circuitry.

The antenna may include a ground point configured to couple to a ground member.

The antenna may be defined on one or more surfaces of the second molded part.

The antenna may be formed by laser direct structuring.

The second molded part may comprise a plateable plastic and the antenna may be plated on the plateable plastic.

The first molded part may include one or more sink marks, and the second molded part may at least partially occupy the one or more sink marks, the second molded part having substantially no sink marks.

According to various, but not necessarily all, embodiments of the invention there is provided an electronic device comprising an apparatus as described in any of the preceding paragraphs.

According to various, but not necessarily all, embodiments of the invention there is provided a method comprising: molding a first molded part including a plurality of protrusions; and molding a second molded part at least to the plurality of protrusions of the first molded part, the second molded part including an antenna configured to resonate at radio frequencies.

The first molded part may define a cavity and the plurality of protrusions may be positioned within the cavity, the second molded part may at least partially occupy the cavity.

The plurality of protrusions may comprise ribs extending along a longitudinal axis of the first molded part.

The cavity may define an upper surface and a lower surface, and a first subset of the plurality of protrusions may extend from the upper surface and a second subset of the plurality of protrusions may extend from the lower surface.

The antenna may include a feed point configured to couple to radio frequency circuitry.

The antenna may include a ground point configured to couple to a ground member.

The antenna may be defined on one or more surfaces of the second molded part.

The antenna may be formed by laser direct structuring.

The second molded part may comprise a plateable plastic and the antenna may be plated on the plateable plastic.

The first molded part may include one or more sink marks, and the second molded part at least partially occupies the one or more sink marks, the second molded part having substantially no sink marks.

### BRIEF DESCRIPTION

For a better understanding of various examples of embodiments of the present invention reference will now be made by way of example only to the accompanying drawings in which:

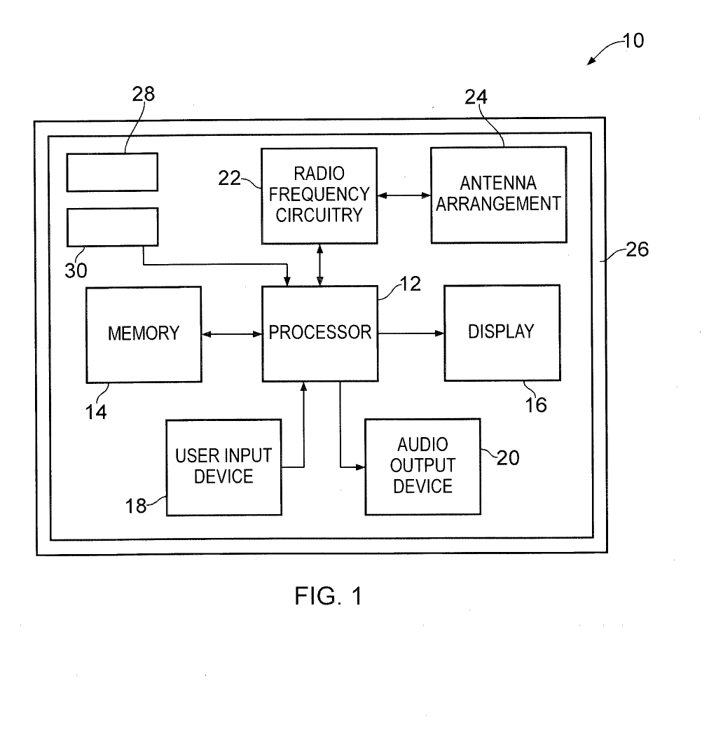

FIG. 1 illustrates a schematic diagram of an electronic device according to various embodiments of the present invention;

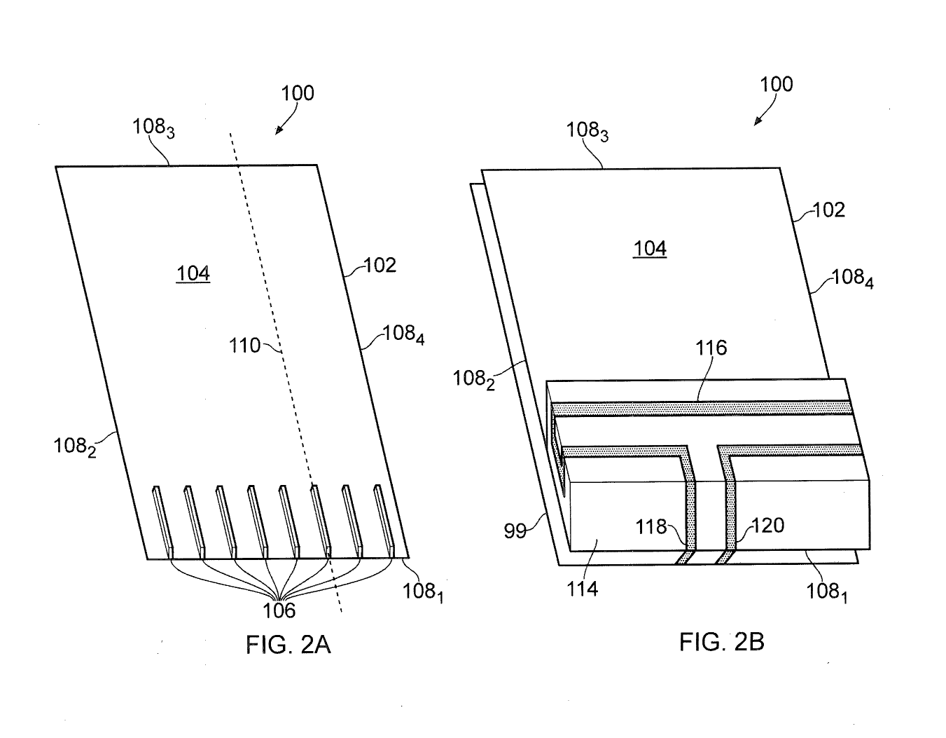

FIG. 2A illustrates a perspective view of a first molded part of a further apparatus according to various embodiments of the present invention;

FIG. 2B illustrates a perspective view of the first molded part illustrated in FIG. 2A and a second molded part according to various embodiments of the present invention;

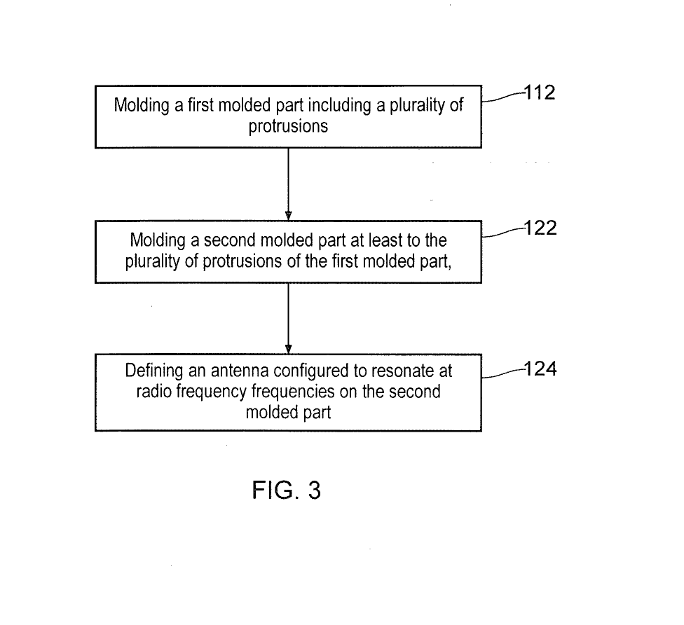

FIG. 3 illustrates a flow diagram of a method of forming an apparatus according to various embodiments of the present invention;

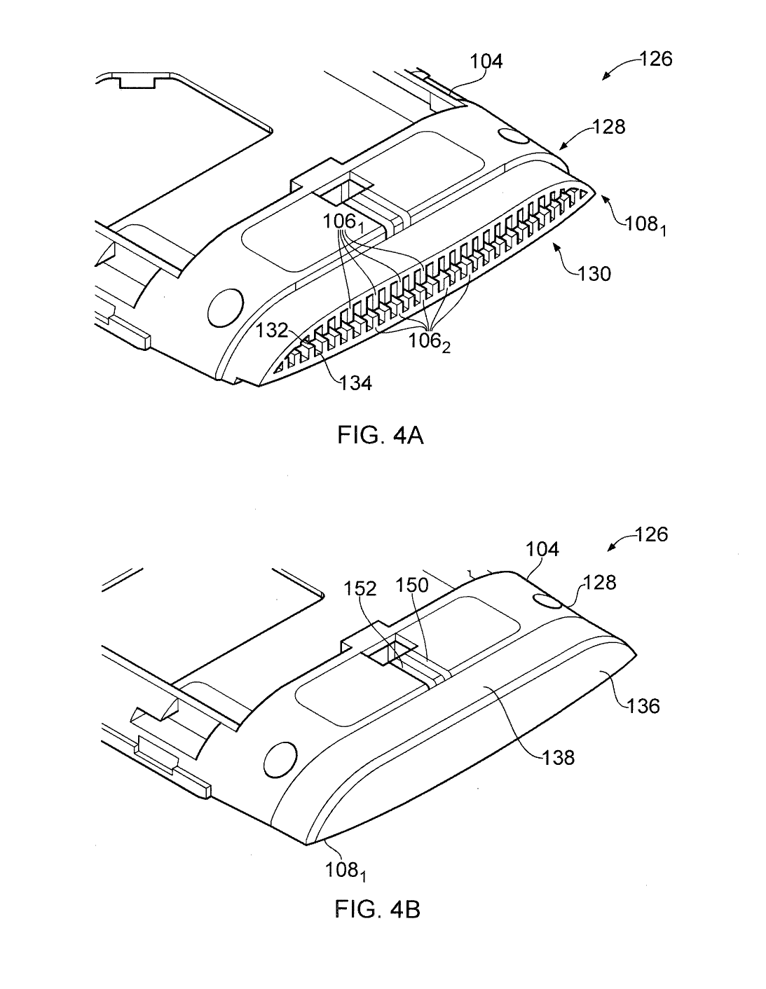

FIG. 4A illustrates a perspective view of a first molded part of another apparatus according to various embodiments of the present invention;

FIG. 4B illustrates a perspective view of the first molded part illustrated in FIG. 4A and a second molded part according to various embodiments of the present invention; and

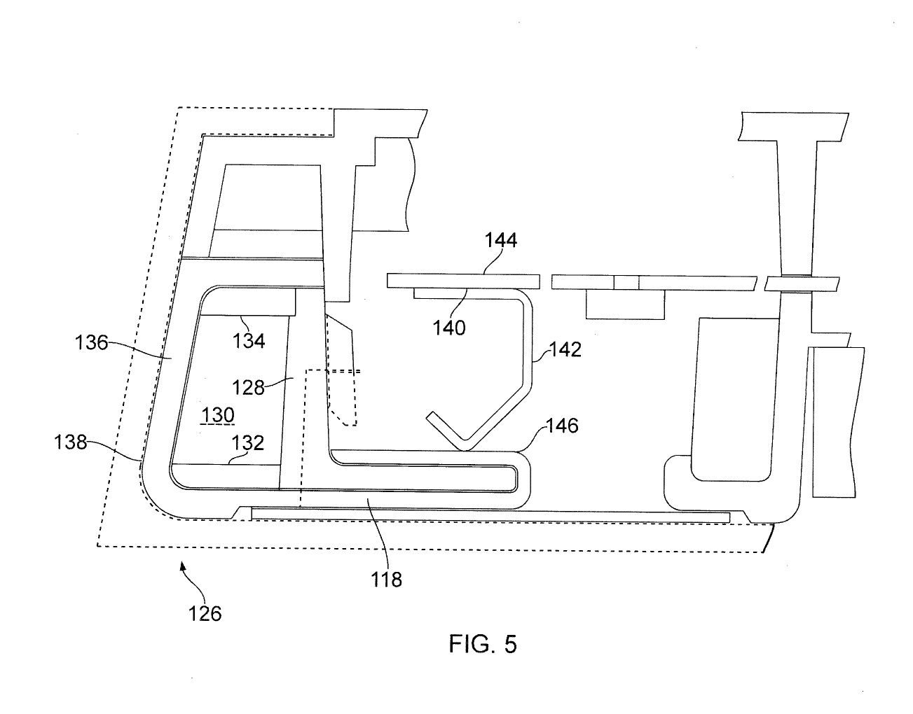

FIG. 5 illustrates a cross sectional side view of the apparatus illustrated in FIG. 4B.

### DETAILED DESCRIPTION

In the following description, the wording ‘connect’ and ‘couple’ and their derivatives mean operationally connected or coupled. It should be appreciated that any number or combination of intervening components can exist (including no intervening components).

FIG. 1 illustrates an electronic device 10 which may be any apparatus such as a portable electronic device (for example, a mobile cellular telephone, a tablet computer, a laptop computer, a personal digital assistant or a hand held computer), a non-portable electronic device (for example, a personal computer or a base station for a cellular network), a portable multimedia device (for example, a music player, a video player, a game console and so on) or a module for such devices. As used here, ‘module’ refers to a unit or apparatus that excludes certain parts or components that would be added by an end manufacturer or a user.

The electronic device 10 may comprise one or more processors 12, one or more memories 14, a display 16, a user input device 18 (such as a keypad), an audio output device 20 (such as a loudspeaker), radio frequency circuitry 22 (such as a transmitter, a receiver and/or a transceiver), an antenna arrangement 24, a housing 26, an electrical energy storage device 28 and an audio input device 30. It should be appreciated that different electronic devices may have different electronic components and that some of the above mentioned components may not be included in some devices. For example, a personal computer may not include the radio frequency circuitry 22 and the antenna arrangement 24 in some embodiments.

The housing 26 is configured to house at least some of the electronic components of the device 10 and may therefore provide an exterior surface of the electronic device 10. The housing 26 includes two or more cover parts which may be fastened to one another to conceal the electronic components of the device 10.

The electrical energy storage device 28 is configured to provide electrical energy to at least some of the electronic components of the electronic device 10. The electrical energy storage device 28 may include one or more electrochemical cells and/or one or more capacitors (such as electric double layer capacitors) for example.

FIG. 2A illustrates a perspective view of a first molded part 102 of an apparatus 100 according to various embodiments of the present invention. The apparatus 100 may be any molded part of the electronic device 10 and may be a cover part of the housing 26 or a structure internal to the device 10 such as a chassis or frame.

The first molded part 102 includes a substantially planar body 104 and a plurality of protrusions 106. The body 104 is rectangular in shape and has a perimeter defined by a first edge 108₁, a second edge 108₂, a third edge 108₃ and a fourth edge 108₄. The first molded part 102 has a longitudinal axis 110 that extends between the first edge 108₁ and the third edge 108₃. It should be appreciated that in other embodiments, the body 104 may have any shape (for example, the body may be circular, elliptical, square in shape and so on)

The plurality of protrusions 106 are positioned at the first edge 108₁ and protrude out of the planar body 104. In this embodiment, the plurality of protrusions 106 comprise ribs that extend along the longitudinal axis 110 of the first molded part 102 for a portion of the distance between the first edge 108₁ and the third edge 108₃. In other embodiments, the plurality of protrusions 106 may have a different shape such as a hemisphere protruding from the body 104 and the plurality of protrusions 106 may have different shapes to one another.

With reference to FIG. 3, the first molded part 102 is formed in a first shot (block 112) of a two shot molding process. At block 112, the method includes molding the first molded part 102 including the body 104 and the plurality of protrusions 106 in a first mold tool cavity. It should be appreciated that the body 104 and the plurality of protrusions 106 are molded in the same shot and are therefore integral with one another and do not have a joining interface.

FIG. 2B illustrates a perspective view of the first molded part 102 illustrated in FIG. 2A and a second molded part 114 according to various embodiments of the present invention. The second molded part 114 overlays the body 104 at the first edge 108₁ and is molded to the plurality of protrusions 106 and to the body 104. In this embodiment, the second molded part 114 has a cuboid shape, but may have other shapes in other embodiments.

The second molded part 114 includes an antenna 116 configured to resonate at radio frequencies and which forms part of the antenna arrangement 24 illustrated in FIG. 1. The antenna 116 may be non-planar and may be formed on a plurality of surfaces of the second molded part 114. For example, the antenna 116 illustrated in FIG. 2B extends on the top surface of the second molded part 114 and on three side surfaces of the second molded part 114.

The antenna 116 includes a feed point 118 configured to couple to radio frequency circuitry 22 and optionally a ground point 120 configured to couple to a ground member 99 (for example, a conductive layer of a printed wiring board of the electronic device 10). In some embodiments, the feed point 118 may be a capacitive coupling (that is, there is no physical connection), and in other embodiments, the feed point may be a galvanic contact.

In some embodiments, the antenna 116 may also be connected to matching circuitry at or near the feed point 118 and/or to loading circuitry at or near the ground point 120. Furthermore, in some embodiments, the feed point 118 and the ground point 120 may be formed on two different surfaces of the second molded part 114 respectively. In some embodiments there may be a plurality of antennas disposed on the second molded part 114. The plurality of antennas may in some embodiments share a common feed point and optionally one or more ground points, and alternatively in some embodiments the plurality of antennas may include an individual feed point for each antenna, and optionally one or more individual ground points for each antenna. In some embodiments there may only be at least one portion of an antenna 116 disposed on the second molded part 114, where at least a second portion of the antenna 116 is disposed on the first molded part 102 or on a separate part (not illustrated). A separate part may be any one of a ceramic block, a separate plastic molding not formed by the two shot molding process, or a printed wiring board.

The radio frequency circuitry 22 and the antenna 114 are configured to operate in one or more operational resonant frequency bands and via one or more protocols. For example, the operational frequency bands and protocols may include (but are not limited to) Long Term Evolution (LTE) (US) (734 to 746 MHz and 869 to 894 MHz), Long Term Evolution (LTE) (rest of the world) (791 to 821 MHz and 925 to 960 MHz), amplitude modulation (AM) radio (0.535-1.705 MHz); frequency modulation (FM) radio (76-108 MHz); Bluetooth (2400-2483.5 MHz); wireless local area network (WLAN) (2400-2483.5 MHz); helical local area network (HLAN) (5150-5850 MHz); global positioning system (GPS) (1570.42-1580.42 MHz); US—Global system for mobile communications (US-GSM) 850 (824-894 MHz) and 1900 (1850-1990 MHz); European global system for mobile communications (EGSM) 900 (880-960 MHz) and 1800 (1710-1880 MHz); European wideband code division multiple access (EU-WCDMA) 900 (880-960 MHz); personal communications network (PCN/DCS) 1800 (1710-1880 MHz); US wideband code division multiple access (US-WCDMA) 1700 (transmit: 1710 to 1755 MHz, receive: 2110 to 2155 MHz) and 1900 (1850-1990 MHz); wideband code division multiple access (WCDMA) 2100 (transmit: 1920-1980 MHz, receive: 2110-2180 MHz); personal communications service (PCS) 1900 (1850-1990 MHz); time division synchronous code division multiple access (TD-SCDMA) (1900 MHz to 1920 MHz, 2010 MHz to 2025 MHz), ultra wideband (UWB) Lower (3100-4900 MHz); UWB Upper (6000-10600 MHz); digital video broadcasting—handheld (DVB-H) (470-702 MHz); DVB-H US (1670-1675 MHz); digital radio mondiale (DRM) (0.15-30 MHz); worldwide interoperability for microwave access (WiMax) (2300-2400 MHz, 2305-2360 MHz, 2496-2690 MHz, 3300-3400 MHz, 3400-3800 MHz, 5250-5875 MHz); digital audio broadcasting (DAB) (174.928-239.2 MHz, 1452.96-1490.62 MHz); radio frequency identification low frequency (RFID LF) (0.125-0.134 MHz); radio frequency identification high frequency (RFID HF) (13.56-13.56 MHz); radio frequency identification ultra high frequency (RFID UHF) (433 MHz, 865-956 MHz, 2450 MHz).

A frequency band over which an antenna can efficiently operate using a protocol is a frequency range where the antenna's return loss is less than an operational threshold. For example, efficient operation may occur when the apparatus' return loss is better than (that is, less than) −4 dB or −6 dB.

With reference to FIG. 3, the second molded part 114 is formed in a second shot (block 122) of the two shot injection molding process. At block 122, the method includes molding the second molded part 114 to the first molded part 102. In more detail, the first molded part 102 is removed from the first mold tool cavity and then placed in a second mold tool cavity (which is different to the first mold tool cavity). The second molded part 114 is then molded locally at the first edge 108₁ of the body 104.

At block 124, the method includes defining the antenna 116 on the second molded part 114. In some embodiments, the one or more conductive tracks of the antenna 116 are formed by performing laser direct structuring (LDS) on the second molded part 114. In other embodiments, the antenna 116 may be formed by another suitable method such as SBID (Super beam induced deposition) or similar methods. In some two shot molding techniques, the first shot may comprise a non-plateable plastic material and the second shot may comprise a plateable plastic material. After the molding of the second shot is completed, any second shot plastic material which is freely available, in other words it is accessible by a further plating process, may then be plated in said plating process.

FIG. 4A illustrates a perspective view of a first molded part 128 of another apparatus 126 according to various embodiments of the present invention. The apparatus 126 is similar to the apparatus 100 illustrated in FIGS. 2A and 2B and where the features are similar, the same reference numerals are used. It should be appreciated that block 112 of the method illustrated in FIG. 3 may be performed to mold the first molded part 128.

In this embodiment, the first molded part 128 defines a cavity 130 at the first edge 108₁ of the body 104. The cavity 130 defines an interior upper surface 132 and an interior lower surface 134 and the plurality of protrusions 106 are positioned within the cavity 130. In particular, a first subset 106₁ of the plurality of protrusions 106 extend perpendicularly from the upper surface 132 into the cavity 130 and a second subset 106₂ of the plurality of protrusions 106 extend from the lower surface 134 into the cavity 130.

FIG. 4B illustrates a perspective view of the first molded part 128 illustrated in FIG. 4A and a second molded part 136 according to various embodiments of the present invention. It should be appreciated that blocks 122 and 124 of the method illustrated in FIG. 3 may be performed to mold the second molded part 136 to the first molded part 128.

The second molded part 136 is molded to, and at least partially occupies the cavity 130 and is therefore molded to the plurality of protrusions 106. The second molded part 136 also overlays the body 104 at the first edge 108₁ and is also molded to the exterior of the portion of the body 104 that defines the cavity 130.

The second molded part 136 includes an antenna 138 configured to resonate at radio frequencies and which forms part of the antenna arrangement 24 illustrated in FIG. 1. The antenna 138 is non-planar and is formed on a plurality of surfaces of the second molded part 136. The antenna 138 may be formed on the second molded part 136 according to any suitable method and may be formed by laser direct structuring for example. The antenna pattern is not illustrated in FIG. 4B for clarity purposes. However, it should be appreciated that the antenna 138 may have any suitable pattern on the second molded part 136.

The antenna 138 includes a portion 150 extending to a feed point (not illustrated in this figure) which is configured to couple to radio frequency circuitry 22, and a portion 152 extending to a ground point (not illustrated in this figure) which is configured to couple to a ground member (such as the ground member 99 illustrated in FIG. 2B which may, for example, be a conductive layer of a printed wiring board of the electronic device 10). In some embodiments, the antenna 138 may also be connected to matching circuitry at or near the feed point 118 and/or to loading circuitry at or near the ground point. In some embodiments, the portion 152 may not be needed and the antenna 138 may not be configured to couple to the ground member 99, therefore a ground point may also not be necessary. This is because some antenna types, for example monopoles, do not require a ground connection between the antenna 138 and the ground member 99. Antenna types which do require a ground connection between the antenna 138 and the ground member 99 may be planar inverted-F antennas (PIFAs), inverted-F antennas (IFAs), loop antennas (unbalanced or single-ended) and patch antennas as non-limiting examples.

The radio frequency circuitry 22 and the antenna 138 are configured to operate in one or more operational resonant frequency bands and via one or more protocols (such as, and not limited to, any of the frequency bands and protocols mentioned previously).

Various embodiments of the present invention provide several advantages. Firstly, when the first molded part 102, 128 is molded, it may include one or more sink marks. When the second molded part 114, 136 is molded, the second molded part 114, 136 at least partially occupies the one or more sink marks (if such marks occurs) of the first molded part 102, 128 and is molded around the protrusions 106 and this results in an apparatus 100, 126 that has few or no sink marks. Since the apparatus 100, 126 has few or no sink marks, the surface quality may be high enough for laser direct structuring (LDS), or a similar process, to be performed to form conductive tracks for the antenna 116, 138 on the second molded part 114, 136. As laser direct structuring and other such processes are relatively accurate, the antenna 116, 138 may have consistent bandwidth, efficiency, impedance matching and so on between different apparatus formed according to this method.

Secondly, the integration of the antenna 116, 138 with the first molded part 102, 128 within an electronic device 10 provides relatively accurate antenna placement relative to other parts of the electronic device 10. This may help to reduce mechanical tolerances when several parts of the electronic device 10 are brought together during manufacture.

Another advantage is that a complex three dimensional antenna may be produced which has a feed arrangement 118, 140, 142, 144 which is configured to provide a maximum electromagnetic near-field region at the feed interface between the antenna feed points and the contact points on the printed wiring board. This may help to concentrate any maximum regions of the near-fields at or near the feed points, where the feed points are physically located inside the device due to the complex three dimensional molding technique. As illustrated in FIG. 5, the second molded part 136 includes a U shaped portion (which includes the portion 118) and the feed point 140 (the interface between the contact 142 and the printed wiring board 144) makes contact with an inner surface 146 of the U shaped portion of the molded antenna 138. The contact 142 may, for example, be a conductive ‘spring’ contact made from metal or other suitable conductive material. The inner surface 146 can be seen where the v-shape of the spring contact 142 makes contact with the antenna 138. The complex 3D shape of the apparatus 126 enables this type of feed point interface as any conductive traces may be provided on multiple surfaces of the apparatus 126.

It should be appreciated that FIG. 5 illustrates a cross section of the apparatus 126 that is not through the protrusions 106. It should also be appreciated that FIG. 5 illustrates the cavity 130 as unoccupied by the second molded part 136 for clarity only and that the cavity 130 is at least partially occupied by the second molded part 136.

The blocks illustrated in FIG. 3 may represent steps in a method and/or sections of code in a computer program. One or more processors of a manufacturing apparatus may read the computer program and control machinery to perform the blocks in FIG. 3. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus comprising:
a first molded part including a plurality of protrusions; and
a second molded part, molded at least to the plurality of protrusions of the first molded part, the second molded part including an antenna configured to resonate at radio frequencies.

2. An apparatus as claimed in claim 1, wherein the first molded part defines a cavity and the plurality of protrusions are positioned within the cavity, the second molded part at least partially occupies the cavity.

3. An apparatus as claimed in claim 1, wherein the plurality of protrusions comprise ribs extending along a longitudinal axis of the first molded part.

4. An apparatus as claimed in claim 3, wherein the cavity defines an upper surface and a lower surface, and a first subset of the plurality of protrusions extend perpendicularly from the upper surface and a second subset of the plurality of protrusions extend from the lower surface.

5. An apparatus as claimed in claim 1, wherein the antenna includes a feed point configured to couple to radio frequency circuitry.

6. An apparatus as claimed in claim 1, wherein the antenna includes a ground point configured to couple to a ground member.

7. An apparatus as claimed in claim 1, wherein the antenna is defined on one or more surfaces of the second molded part.

8. An apparatus as claimed in claim 7, wherein the antenna is formed by laser direct structuring.

9. An apparatus as claimed in claim 1, wherein the second molded part comprises a plateable plastic and the antenna is plated on the plateable plastic.

10. An apparatus as claimed in claim 1, wherein the first molded part includes one or more sink marks, and the second molded part at least partially occupies the one or more sink marks, the second molded part having substantially no sink marks.

11. An electronic device comprising an apparatus as claimed in claim 1.

12. A method comprising:
molding a first molded part including a plurality of protrusions; and
molding a second molded part at least to the plurality of protrusions of the first molded part, the second molded part including an antenna configured to resonate at radio frequencies.

13. A method as claimed in claim 12, wherein the first molded part defines a cavity and the plurality of protrusions are positioned within the cavity, the second molded part at least partially occupies the cavity.

14. A method as claimed in claim 12, wherein the plurality of protrusions comprise ribs extending along a longitudinal axis of the first molded part.

15. A method as claimed in claim 14, wherein the cavity defines an upper surface and a lower surface, and a first subset of the plurality of protrusions extend from the upper surface and a second subset of the plurality of protrusions extend from the lower surface.

16. A method as claimed in claim 12, wherein the antenna includes a feed point configured to couple to radio frequency circuitry.

17. (canceled)

18. A method as claimed in claim 12, wherein the antenna is defined on one or more surfaces of the second molded part.

19. A method as claimed in claim 18, wherein the antenna is formed by laser direct structuring.

20. A method as claimed in claim 12, wherein the second molded part comprises a plateable plastic and the antenna is plated on the plateable plastic.

21. A method as claimed in claim 12, wherein the first molded part includes one or more sink marks, and the second molded part at least partially occupies the one or more sink marks, the second molded part having substantially no sink marks.
